(19) United States
(12) Patent Application Publication
(10) Pub. No.: US 2006/0008619 A1
(43) Pub. Date: Jan. 12, 2006

(54) Liner with different impressments at opposing surfaces

(76) Inventors: Ewen Campbell, Winchester, VA (US); Tim Lettie, Berryville, VA (US); Joe A. Powell, Wadsworth, OH (US); John H. Hornickel, Medina, OH (US)

Correspondence Address: John H Hornickel;PolyOne Corporation, 33587 Walker Road, Avon Lake, OH, 44012, US

(21) Appl. No.: 10/537,377

(22) PCT Filed: Dec. 2, 2003
(86) PCT No.: PCT/US03/38237

§ 371 Date: Jun. 3, 2005

Related U.S. Application Data
(60) Provisional application No. 60/431,308, filed on Dec. 6, 2002.

(51) Int. Cl. B32B 3/00

(52) U.S. Cl. 428/156

(57) ABSTRACT

The invention relates to a film having two major, opposing surfaces and impressments at both opposing surfaces. The film is useful as a liner, especially a waterproof liner such as a shower pan liner. The impressments take the form of at least a line, an indicium, or both. The lines can be rectilinear, curvilinear, or a combination of both in random or organized segments and can be measured in any system of units or combination of units. The indicia impressed at each surface of the waterproof liner can be in the same or different languages.

### FIELD OF THE INVENTION

The present invention relates to liners for use in the construction industry having impressments, such as plumbing requirements and code specifications.

### BACKGROUND OF THE INVENTION

Liners, especially waterproof liners, are used in the construction industry for various applications. For example, the liner can be used as a barrier layer to prolong the durability of a substrate by protecting it from deterioration due to moisture. An example is a shower pan liner, which is dispensed from a roll.

Indicia on one side of the liner aids in its use. Commercial examples of such waterproof liners are marketed by Nervastral, Inc. of Greenwich, Conn.; and Omnova Solutions of Fairlawn, Ohio.

The disclosure of U.S. Pat. No. 6,352,760 B1 teaches the embossing of construction industry information indicia on at least one surface of a waterproof liner.

### SUMMARY OF THE INVENTION

What is needed in the art is a liner that provides impressments at both of the major, opposing surfaces of the liner.

One aspect of the invention is a liner comprising a film having two major, opposing surfaces and impressments at both opposing surfaces.

“Impressment” means a depression, a groove, a recess or an indentation located “at” a major surface of the liner and in the form of at least a line, an indicium, or both.

“At” means the impressment is part of a continuous exposure of the major surface but at a different elevation from the major surface that has not been subjected to an impression processing step. The result of the impression processing step can be a displacement of mass within a single post-processing thickness of liner altered from a single pre-processing thickness of liner, a displacement of mass that displaces the pre-processing thickness of liner only at the locations of impression to form embossments extending from the opposing major surface, or combinations thereof. Therefore, viewed from the perspective of a location within the impressment, the impressment is “on” the surface of the liner. However, viewed from the perspective of a location not within the impressment, the impressment is “in” the surface of the liner. Regardless of the perspective, the impressment remains exposed in a direction orthogonal to the major surface of the liner.

“Line” means a series of points extending from a starting point in any direction and employing any system of geometry. Preferably, the line uses Euclidean geometry and can be rectilinear, curvilinear, or a combination of both in random or organized segments.

“Indicium” means a symbol, or fragment thereof, which conveys meaning, alone or in combination with other indicia, at least numerically, graphically, or textually, or any combination of them. Without limitation, indicia includes information with respect to source of manufacture, brands, assembly instructions, use instructions, warnings, cautions, construction codes, building codes, physical test data, quality assurance, and combinations thereof.

Another aspect of the present invention is a method of maling a liner having impressments at both major, opposing surfaces, comprising the step of impressing a thermoplastic film at both major, opposing surfaces.

An advantage of the present invention is that the lines to be impressed at each surface of the waterproof liner can be selected by the manufacturer to serve different markets, such as the United States (which uses the English system of measurement) and Canada (which uses the Metric system of measurement).

Another advantage of the present invention is that the information to be impressed at each surface of the waterproof liner can be selected by the manufacturer to serve different users who work in different languages, such as English and Spanish (useful for the United States and Mexico) and French and English (useful for Canada).

Other advantages of the invention will be revealed below when describing embodiments in view of the following drawings.

### BRIEF DESCRIPTION OF THE DRAWINGS

FIG. 1 is a perspective view showing one major surface of the shower liner material of the present invention with impressments thereon.

FIG. 2 is a cross-sectional view of the shower pan liner taken at line 2-2 of FIG. 1 or at line 2-2 of FIG. 3.

FIG. 3 is a perspective view showing a fractional view of the opposing major surface of the shower liner material of the present invention, as compared with the surface shown in FIG. 1 with different impressments thereon.

### EMBODIMENTS OF THE INVENTION

A liner is shown in FIG. 1 and is generally indicated by the numeral 10. The liner is made from a thermoplastic polymer.

Suitable polymers include any thermoplastic polymer capable of forming a flexible film capable of being impressed. Thermoplastic polymers include thermoplastic plastics and thermoplastic elastomers.

The thermoplastic polymer is derived preferably from olefin monomers containing from 2 to 4 carbon atoms. Nonlimiting examples of polyolefins include poly(vinyl chloride), poly(ethylene), poly(propylene), and the like.

Preferably, the polyolefin is plasticized poly(vinyl chloride), wherein the amount of plasticizer ranges generally from about 45 to about 75 parts by weight and preferably from about 55 to about 65 parts by weight per 100 parts by weight of poly(vinyl chloride).

The thickness of the liner is generally sufficient to form a suitable film or sheet for use in the construction and building industry. Suitable thicknesses generally range from about 15 to about 80 mils, (about 0.4 to about 2 mm). Desirably, the thickness is from about 20 to about 60 mils (about 0.5 to about 1.5 mm). Preferably, the thickness is from about 25 to about 45 mils (about 0.6 to about 1.1 mm). Since the liner material is flexible, as shown in FIG. 1, it is often produced and stored in the form of a roll.

The liner 10 can be fluid pervious, fluid impervious, or specific fluid pervious. The liner can be gas pervious but liquid impervious. The liner can be impervious to one liquid but pervious to another liquid. The choice of perviousness is based on the location and usage of the liner. The present invention directed to impressments at both major surfaces of the liner reflects information needed or desired for the location and usage of the liner, not the composition, morphology, or rheology of the liner itself aside from the ability to create and retain impressments in both major surfaces in an impression processing step.

On one of the major surfaces 11 is a series of impressed lines 12, desirably located at spaced intervals of any desired distance, as measured in any system of units or combination of units. For example, one can have:

(a) A system of measurement in English units, such as inches, feet, yards, etc.;

(b) A system of measurement in Metric units, such as centimeters and meters, etc.;

(c) A system of measurement in absolute terms unique to the construction industry, such as the distance between vertical studs in residential home construction; or

(d) A combination of system of measurements such as having both English units and Metric units impressed at the same surface.

Lines 12 are substantially perpendicular (i.e., form an angle of from about 80 to about 100 degrees and preferably about 90 degrees) with respect to the length of the roll. Impressed lines 12 can be continuous or discontinuous. Optionally, impressed lines 12 can be intersected with additional lines (not shown) substantially in parallel with the edges of the liner 10 and substantially perpendicular to lines 12, thus forming a grid for additional ease of use.

Also at surface 11 can be impressed indicia 14 described in greater detail below.

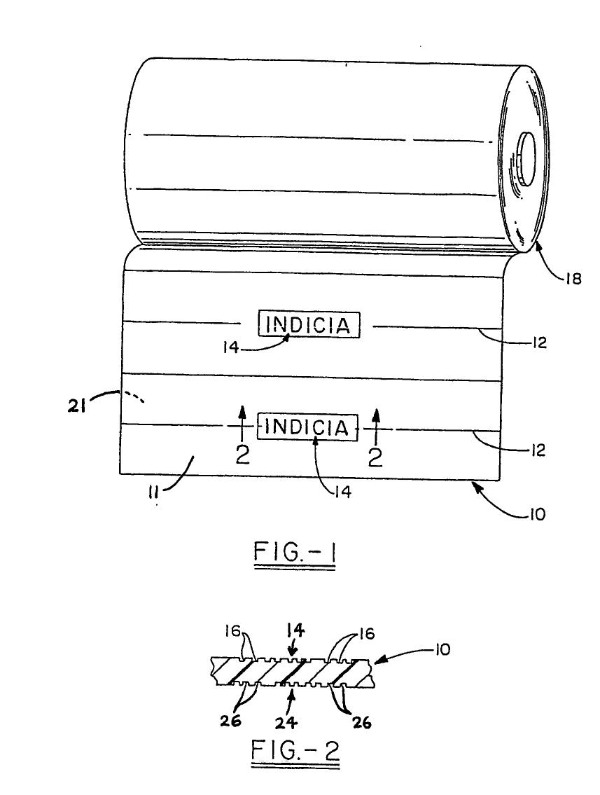

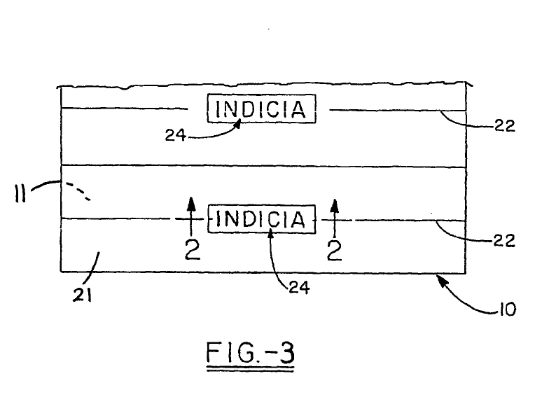

As seen in FIG. 2, the depth of the impressments 16 is not important so long as it is visually apparent. Typical impressment depths (relative to a continuous unimpressed area of surface 11) can range from about 0.25 to about 15 mils (about 0.006 to about 0.38 mm), with a suitable depth often being about 3 to about 6 mils (about 0.08 to about 0.15 mm). The impressments can be any geometric configuration ranging from hemispherical to squared-off at the bottom 16 thereof.

FIG. 3 shows the opposing major surface 21 of liner 10. At surface 21 is a series of impressed lines 22 therein desirably at spaced intervals of any desired length as measured in any system of units or combination of units. For example, one can have:

(a) A system of measurement in English units, such as inches, feet, yards, etc.;

(b) A system of measurement in Metric units, such as centimeters and meters, etc.;

(c) A system of measurement in absolute terms unique to the construction industry, such as the distance between vertical studs in residential home construction; or

(d) A combination of system of measurements such as having both English units and Metric units impressed at the same surface.

Lines 22 are substantially perpendicular (i.e., form an angle of from about 80 to about 100 degrees and preferably about 90 degrees) with respect to the length of the roll. Impressed lines 22 can be continuous or discontinuous. Optionally, impressed lines 22 can be intersected with additional lines (not shown) substantially in parallel with the edges of the liner 10 and substantially perpendicular to lines 22, thus forming a grid for additional ease of use.

Also at surface 21 can be impressed indicia 24 described in greater detail below.

As seen in FIG. 2, the depth of the impressments 26 is not important so long as it is visually apparent. Typical impressment depths (relative to a continuous unimpressed area of surface 11) can range from about 0.25 to about 15 mils (about 0.006 to about 0.38 mm), with a suitable depth often being about 3 to about 6 mils (about 0.08 to about 0.15 mm). The impressments can be any geometric configuration ranging from hemispherical to squared-off at the bottom 26 thereof.

Impressed indicia 14 and 24 display product information, building code information, installation information, and the like. The information can be in a single language or combination of languages. The indicia 14 and 24 can be expressed in the same language, in two different languages, the same combination of multiple languages, or two different combinations of multiple languages.

When used as a shower pan liner, liner 10 preferably has indicia 14 and 24 relating to different plumbing codes, test data, minimum quality certification, and the like. The shower pan liner can include any number of different impressments 14 and 24 such as 4 or 5, and the same are generally repeated throughout the length of the liner. The plumbing code, quality assurance symbol, brand, etc., impressments can be located at either the major surface 11 or the opposing surface 21 of the liner 10, or both

Preferably, indicia 14 is displayed in one language such as English while indicia 24 is displayed in a different language such as Spanish. In such manner, the liner 10 can be used in different markets or in different construction locations where a different language is dominant in common usage.

Although the liner 10 can be made of numerous sizes and shapes, desirably it is in the form of a roll 18.

The process for forming the roll 18 can vary but generally the thermoplastic, such as the preferred poly(vinyl chloride) is added to a Banbury-type mixer in sufficient amounts along with plasticizer and other additives such as processing aids and the like, and compounded. The mixture is then dropped into a holding mill, for example, a two roll mill, and then fed to an extruder. It is then extruded onto a four roll inverted “L” calender and calendered into a sheet of a suitable width such as 4-6 feet (1.21-1.82 m). Within a suitable distance from the calender so that only a slight cooling occurs, the calendered sheet is fed between an impressing nip roll and an impressing backing roll. The impressing rolls can be made out of either metal or composite material and have desired projections for forming impressments at the opposing surfaces 11 and 21, respectively, of liner 10. Preferably, the impressing nip roll is made of metal and the impressing backing roll is made of a composite material to be used in a technique called “fixed gap embossing”. The composite roll can be purchased from Saueressig of Vreden, Germany. The projections on the composite roll can be formed using laser etching techniques known to those skilled in the art.

From the set of impressing rolls, the thermoplastic liner is fed to cooling rolls and subsequently coiled about a core to form liner roll 18.

The liner is then used as produced. That is, there is no need for printing any verbiage, indicia, or logo thereon, and the liner is preferably completely free of any such printed matter. Similarly, the need for additional layers to protect any printed matter is also eliminated. The liner 10 is subsequently free of any protective coatings and preferably completely free thereof.

The liners of the present invention can be installed in any construction usage according to the composition, morphology, or rheology suitable for the liner 10. Preferably, the liner 10 can serve as a waterproof shower pan liner at a shower facility under construction. At this point, the user selects which major surface 11 or 21 will be visible as the top or exposed surface.

In large industrial showers as in factories, gymnasiums, and the like, the flexible impressed waterproof thermoplastic shower liner is laid over the substrate material such as concrete. In a home application, a shower pan liner is generally laid over a wood base with the bathtub or fiberglass shower stall, etc., placed there over.

A portion of the liner sheet is laid against any upstanding or vertical wall at the end of the shower area so that a lip is formed. To the remaining edge of the liner sheet, an adhesive or glue is applied and a second sheet applied parallel to the first. This procedure is repeated generally until the lowest most point of the shower is reached. Then the entire immediately above-noted procedure is repeated on the other side of the shower until the entire shower facility floor is lined and completely covered with the liner of the present invention A hole in the liner can then be made over the drain. Ceramic tiles and mortar can be applied over the liner of the present invention. Of course, other flooring can be utilized such as concrete or thick mortar.

If the tile, mortar or concrete crack or break, the shower pan liner acts as a waterproof barrier to prevent the water from reaching the concrete substrate.

In addition to as functioning as a liner with regard to a shower facility, the liner material of the present invention can be used in other building or construction sites wherever a waterproof barrier over a concrete substrate, etc., is desired.

Usefulness of the Invention

The present invention unexpectedly advances the art of construction liners by providing multiple variations according to the needs of the local construction industry.

Minimally, the present invention requires impressments at opposing major surfaces. The impressments at opposing surfaces can be lines only at both surfaces, indicia only at both surfaces, lines at one major surface and indicia at the opposing major surface, or both lines and indicia at both surfaces.

Preferably, the present invention employs both lines and indicia at both surfaces. Within that preference, there are many different variations possible within the scope of the present invention.

Those variations include:
1. Lines 12 and 22 in a single system of units ((a)-(c) described above) with Indicia 14 in a first language and Indicia 24 in a second language.
2. Lines 12 in a first system of units, lines 22 in a second system of units, with Indicia 14 and 24 in a single language.
3. Lines 12 in a first system of units, lines 22 in a second system of units, with Indicia 14 in a first language and Indicia 24 in a second language.
4. Lines 12 and 22 in a single system of units with Indicia 14 and 24 in a single language.
5. Lines 12 and 22 in a single system of units with Indicia 14 in a combination of languages and Indicia 24 in a different combination of languages.
6. Lines 12 in a first system of units, lines 22 in a second system of units, with Indicia 14 and 24 in a combination of languages.
7. Lines 12 in a first system of units, lines 22 in a second system of units, with Indicia 14 in a combination of languages and Indicia 24 in a different combination of languages.
8. Lines 12 and 22 in a single system of units with Indicia 14 and 24 in a combination of languages.
9. Lines 12 and 22 in a combination of systems of units with Indicia 14 in a first language and Indicia 24 in a second language.
10. Lines 12 in a first system of a combination of systems of units, lines 22 in a second combination of systems of units, with Indicia 14 and 24 in a single language.
11. Lines 12 in a combination of systems of units, lines 22 in a second combination of systems of units, with Indicia 14 in a first language and Indicia 24 in a second language.
12. Lines 12 and 22 in a combination of systems of units with Indicia 14 and 24 in a single language.
13. Lines 12 and 22 in a combination of systems of units with Indicia 14 in a combination of languages and Indicia 24 in a different combination of languages.
14. Lines 12 in a first combination of systems of units, lines 22 in a second combination of systems of units, with Indicia 14 and 24 in a combination of languages.
15. Lines 12 in a first combination of systems of units, lines 22 in a second combination of systems of units, with Indicia 14 in a combination of languages and Indicia 24 in a different combination of languages.
16. Lines 12 and 22 in a combination of systems of units with Indicia 14 and 24 in a combination of languages.

Once the various system of units are enumerated and the various languages are enumerated, one skilled in the art can perceive the tremendous variation possible according to the needs of serving a global construction industry with a single liner product adapted to meet local use.

The invention is not limited to the above embodiments. The claims follow.

What is claimed is:

1. A liner, comprising:
a film having two major, opposing surfaces and impressments at both opposing surfaces,
wherein each impressment comprises a depression, groove, recess, or indentation in the form of at least an indicium,
wherein the impressments are continuous or discontinuous, and
wherein the indicium is a symbol or fragment of a symbol displaying numerical, graphical, or textual information.

2. The liner of claim 1, wherein the information comprises source of manufacture, brands, assembly instructions, use instructions, warnings, cautions, construction codes, building codes, physical test data, quality assurance, or combinations thereof.

3. The liner of claim 2, wherein the impressments at both opposing surfaces convey different information.

4. The liner of claim 3, wherein the impressments on one opposing surface conveys information in one system of measurement and the impressments on the other opposing surface conveys information in another system of measurement.

5. The liner of claim 3, wherein the impressments on one opposing surface conveys information in language and the impressments on the other opposing surface conveys information in another language.

6. The liner of claim 1, wherein the liner is made of a flexible film of thermoplastic polymer that is fluid pervious, fluid impervious, or specific fluid pervious and has a thickness ranging from about 0.4 to about 2 mm.

7. The liner of claim 1, wherein the impressments, relative to a continuous unimpressed area of surface, have a depth ranging about 0.006 to about 0.38 mm in any geometric configuration ranging from hemispherical to squared-off.

8. A method of making a liner of claim 1, comprising the step of impressing a thermoplastic film at both major, opposing surfaces.

9. A liner, comprising:
a film having two major, opposing surfaces and impressments at both opposing surfaces,
wherein each impressment comprises a depression, groove, recess, or indentation in the form of at least an indicium,
wherein the impressments are continuous or discontinuous, and
wherein the impressments at both opposing surfaces convey different information.

10. The liner of claim 9, wherein the information comprises source of manufacture, brands, assembly instructions, use instructions, warnings, cautions, construction codes, building codes, physical test data, quality assurance, or combinations thereof.

11. The liner of claim 9, wherein the impressments on one opposing surface conveys information in one system of measurement and the impressments on the other opposing surface conveys information in another system of measurement.

12. The liner of claim 9, wherein the impressments on one opposing surface conveys information in language and the impressments on the other opposing surface conveys information in another language.

13. The liner of claim 9, wherein the liner is made of a flexible film of thermoplastic polymer that is fluid pervious, fluid impervious, or specific fluid pervious and has a thickness ranging from about 0.4 to about 2 mm.

14. The liner of claim 9, wherein the impressments, relative to a continuous unimpressed area of surface, have a depth ranging about 0.006 to about 0.38 mm in any geometric configuration ranging from hemispherical to squared-off.

15. The liner of claim 11, wherein the liner is made of a flexible film of thermoplastic polymer that is fluid pervious, fluid impervious, or specific fluid pervious and has a thickness ranging from about 0.4 to about 2 mm, and
wherein the impressments, relative to a continuous unimpressed area of surface, have a depth ranging about 0.006 to about 0.38 mm in any geometric configuration ranging from hemispherical to squared-off.

16. The liner of claim 12, wherein the liner is made of a flexible film of thermoplastic polymer that is fluid pervious, fluid impervious, or specific fluid pervious and has a thickness ranging from about 0.4 to about 2 mm, and
wherein the impressments, relative to a continuous unimpressed area of surface, have a depth ranging about 0.006 to about 0.38 mm in any geometric configuration ranging from hemispherical to squared-off.

17. The liner of claim 13, wherein the information comprises source of manufacture, brands, assembly instructions, use instructions, warnings, cautions, construction codes, building codes, physical test data, quality assurance, or combinations thereof.

18. The liner of claim 14, wherein the information comprises source of manufacture, brands, assembly instructions, use instructions, warnings, cautions, construction codes, building codes, physical test data, quality assurance, or combinations thereof.

19. The liner of claim 9, wherein the indicium is a symbol or fragment of a symbol displaying numerical, graphical, or textual information.

20. The liner of claim 11, wherein the indicium is a symbol or fragment of a symbol displaying numerical, graphical, or textual information.
